(19) United States
(12) Patent Application Publication
(10) Pub. No.: US 2015/0129538 A1
(43) Pub. Date: May 14, 2015

(54) METHOD FOR PRODUCING A CAPACITIVE SENSOR

(71) Applicant: COMMISSARIAT À L' ÉNERGIE ATOMIQUE ET AUX ÉNERGIES ALTERNATIVES, Paris (FR)

(72) Inventors: Hubert Grange, Grenoble (FR); Jean-Sebastien Danel, Echirolles (FR); Frédéric-Xavier Gaillard, Voiron (FR)

(21) Appl. No.: 14/395,227

(22) PCT Filed: May 13, 2013
(86) PCT No.: PCT/EP2013/059775

§ 371 Date: Oct. 17, 2014

(30) Foreign Application Priority Data
May 15, 2012 (FR) 12 54464

(51) Int. Cl. H01G 13/00

(52) U.S. Cl. CPC H01G 13/00
USPC 216/6

(57) ABSTRACT

A method for production of a capacitive sensor including a carrier whereupon electrodes separated from each other by a porous material rest, the porous material being made by porosifying trenches formed in a carrier.

### TECHNICAL FIELD

The invention relates to the field of capacitive sensors having a porous material, and applies to the detection of fluid and particularly to gas and/or humidity sensors.

It relates to a method for producing a capacitive sensor device with a porous material.

### STATE OF PRIOR ART

A capacitive sensor consists generally of electrodes provided on either side of a dielectric material layer.

Some capacitive sensors such as gas or humidity sensors integrate a porous material, and have a capacitance likely to vary as a function of a quantity of gas or liquid adsorbed by this material.

The document “A novel surface-micromachined capacitive porous silicon humidity sensor”, Z. M. Rittersma et al., Sensors and Actuators B 68 (2000) 210-217 for example discloses a capacitive sensor having metal electrodes in the form of interdigitated combs or of a grid and comprising a layer of porous semi-conducting material.

The document “Measurement of gas Moisture in the ppm range using porous silicon and porous alumina sensors”, Tarikul Islam et al., Sensors and Materials, Vol. 16, No 7 (2004) 345-356, discloses in turn a capacitive sensor with electrodes deposited on the surface of a layer of nano-porous Si in which the pore diameter is in the order of 1 nm to 3 nm.

Document WO 2010/006877 presents a capacitive sensor with a porous dielectric for detecting low humidity levels, in particular lower than 20% RH, integrating a layer of nano-porous hydrophilic dielectric material with a strong open porosity provided between electrodes. The thickness of the porous dielectric material is relatively low, which may tend to limit the sensitivity of the sensor. Producing a thick layer of porous dielectric material, in particular thicker than 2 micrometres requires to make several deposits.

Document DE 102 46 050 A1 presents an embodiment of a humidity sensor with a porous material obtained by porosifying a carrier.

There rises the problem of finding an improved method for producing a capacitive sensor integrating a porous material, and especially a sensor for detecting a gas and/or humidity and/or for measuring a quantity of gas and/or humidity.

### DISCLOSURE OF THE INVENTION

The present invention relates to producing a capacitive sensor, comprising steps of:
forming several distinct trenches separated from each other in a carrier, then
forming a porous material by porosifying the walls and the bottom of said trenches,
filling the trenches using a conducting material.

Trenches are thereby made in the carrier material which preferably is not porous.

Then the carrier material is made porous once the trenches are made.

The trenches are made by etching the carrier.

By performing the steps of trench etching and porosifying in this order, trenches are more precisely defined than if trenches were formed in a porous material.

By carrying out the steps of trench etching and porosifying in this order, the possibilities of pore damaging are also reduced, which enables a porous material of a better quality to be obtained and in the end, a sensor with an improved sensitivity to be implemented.

The steps of trench etching and porosifying are also implemented in this order, so as to avoid to contaminate the pores of said porous material with a product used to make the trenches.

Filling the trenches by a conducting material can be total or possibly partial and carried out in order to cover the bottom and the walls of the trenches made porous.

Thus, the filling step enables to form electrodes based on said conducting material which are surrounded by porous material and can be insulated from the carrier through the porous material.

The carrier can be a substrate, such as a bulk substrate based on a semi-conductor, in particular based on silicon.

The implementation of such a sensor on a porous substrate is less expensive and less complex to implement than on a SOI substrate (SOI stands for “Silicon on Insulator”). Besides, the insulation can be provided by the porous material and performed without requiring a buried oxide layer.

The carrier can consist of a stack of several layers.

The porous material can advantageously be formed from the substrate material, for example based on silicon made porous.

The porous material can also comprise or be formed of a porous dielectric material.

After porosifying the trenches and prior to their filling with a conducting material, a dielectric material such as MSQ or another insulating material for example having submicronic pore sizes can be formed on said porous material obtained by porosification.

The porous material formed by porosification can be a nano-porous material, that is having pores of nanometric dimension or diameter.

The porous material formed by porosification can be provided with small diameter pores, for example comprised between 2 nm and 100 nm.

The porous material formed by porosification can also be produced with an open porosity greater than 30%.

This enables a significant developed surface to be obtained and a significant number of molecules to be fixed, in particular water molecules when the capacitive sensor is a humidity sensor.

According to a possible implementation of the method, a treatment for making the porous material hydrophilic can be provided.

By carrying out such a treatment, for example by oxidizing the porous material, the hydrophilicity of the latter can be increased.

Implementing hydrophilic sites can in particular be performed for an application of the capacitive sensor as a humidity sensor.

The implemented humidity sensor can then be in particular adapted to detect a low humidity content, for example between 0% RH and 20% RH, or between 0 and 10% RH.

Advantageously, functionalizing the porous material can also be provided.

The porous material can be functionalized, and undergo a functionalization of the surface of the pores by one or several specific compounds enabling the adsorption of determined gases, especially when the capacitive sensor is a gas sensor, in particular adapted to detect very low levels of gas quantity.

The order of the steps of performing the trenches by etching and porosification is all the more important when a functionalization of the porous material and/or a treatment for making this porous material hydrophilic are subsequently performed.

Indeed, implementing such steps requires a maximum reduction of contaminants (such as for example residues or product(s) used for forming the trenches) on the surface of the porous material and in the pores.

The trenches can then be made through a protective masking for protecting areas of the carrier from the porosification step.

The method can further comprise, after the filling step, removing areas of said conducting material protruding from the mouth of the trenches by using the protecting masking as a planarization barrier layer.

The invention also provides a sensor of a capacitive type implemented thanks to a method such as defined above and formed on a carrier comprising: at least one given porous material placed between at least one first electrode and one second electrode, as well as between at least one of the electrodes and the carrier.

The porous material is thus placed under at least one of said electrodes and the carrier in order to electrically insulate said at least one of said electrodes from the carrier.

Such an arrangement of the given porous material enables a better electrical insulation from the carrier to be obtained and a sensitivity of the sensor to be thereby improved.

The given porous material enables a capacitance to be varied as a function of an adsorbed quantity of liquid or gas, while taking part in insulating the capacitance from the carrier.

According to a possible implementation, the sensor can be arranged such that the first electrode and the second electrode are placed in said porous material.

According to a possible implementation, the sensor can be arranged such that the first electrode is provided with at least one conducting branch located between two conducting branches of the second electrode.

These conducting branches can be located in a same plane parallel to the carrier.

The first electrode and the second electrode can be in the form of combs having interdigitated branches.

According to another possible implementation, the first electrode and/or the second electrode can be surrounded by and in contact with one or several layers of porous dielectric material.

According to a particular arrangement, layers of porous dielectric material can be placed on said given porous material.

### BRIEF DESCRIPTION OF THE DRAWINGS

The present invention will be better understood upon reading the description of exemplary embodiments given for indicating purposes only and in no way limiting, by reference to the accompanying drawings on which:

FIGS. 1A and 1B show an exemplary arrangement of a capacitive sensor likely to be implemented using a method according to the invention, and comprising a porous material in which teeth of electrode combs are placed, the porous material being also distributed between a semi-conducting substrate on which the sensor is formed and the electrodes of the latter,

FIGS. 2A to 2E show an exemplary method according to the invention for producing a humidity sensor of the capacitive type comprising a porous material,

FIG. 3 shows an alternative embodiment of a humidity sensor of the capacitive type comprising a porous dielectric material coating a portion of the electrodes, another porous material being placed between the porous dielectric material and the substrate on which the sensor is formed,

FIG. 4 shows another alternative embodiment of an exemplary sensor of the capacitive type comprising a porous dielectric material coating a portion of the electrodes and in contact with the substrate on which the sensor is formed.

Identical, similar or equivalent parts of the given figures bear the same reference numerals so as to facilitate switching from one figure to another.

The different parts in the figures are not necessarily represented according to a uniform scale, in order to make the figures more legible.

### DETAILED DISCLOSURE OF PARTICULAR EMBODIMENTS

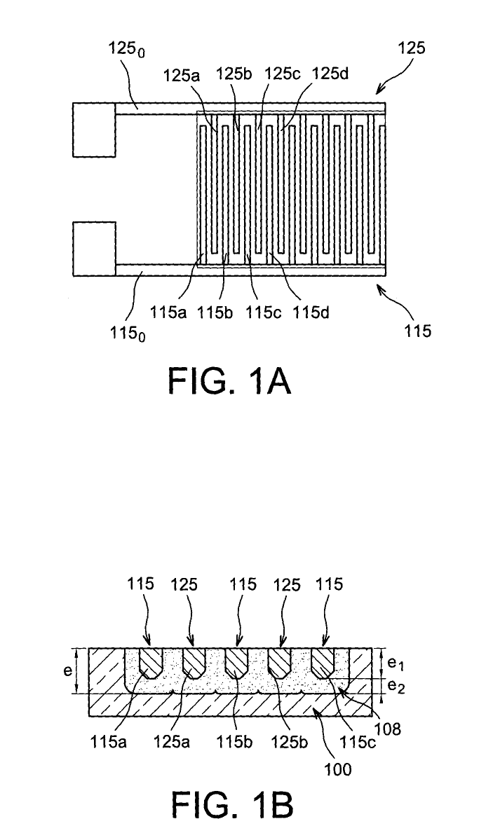

An exemplary capacitive sensor is given in FIGS. 1A-1B.

The sensor is formed on a carrier 100, which can be a substrate based on a semi-conducting material, for example a bulk substrate of silicon.

The sensor comprises electrodes 115, 125 of a capacitance.

A first electrode 115 can be provided with a conducting branch known as “main” conducting branch 115₀ which extends in a given direction parallel to the carrier 100, and conducting branches 115a, 115b, 115c, 115d, known as “secondary” connected to the main branch 115₀ and which extend in a given direction orthogonal to that of the main branch and parallel to the carrier 100.

A second electrode 125 can also be provided with a main conducting branch 125₀ which extends in a given direction parallel to the carrier 100, and secondary conducting branches 125a, 125b, 125c, connected to the main branch and which extend in a given direction orthogonal to the main branch and parallel to the carrier 100.

Electrodes 115, 125 can then each comprise a comb shaped pattern.

In FIG. 1A, the electrodes 115, 125 are represented in a top view and in the form of interdigitated combs.

Thus, electrodes 115 and 125 are placed so that at least one secondary conducting branch 125a of one of the electrodes is located in a same plane parallel to the carrier, between two secondary conducting branches 115a, 115b of the other electrode.

Electrodes 115, 125 are placed in an area of porous material 108 having a thickness e=e₁+e₂ for example between 1 μm and 5 μm.

The thickness e₁ of porous material between the electrodes, corresponding to a height (measured in a direction orthogonal to the carrier plane) of porous material placed between the electrodes, can for example be set to 4 μm, preferably between 1 μm and 5 μm.

Also, the thickness e₂ of porous material between the carrier and at least one of the electrodes can be for example at least 1 μm, preferably between 0.5 μm and 5 μm.

A significant thickness of porous material placed between the electrodes as well as between the electrodes and the carrier contributes to improving the sensitivity of the sensor.

The porous material 108 is placed between the electrodes 115 and 125, and separates the electrodes 115, 125 from the substrate. It can thereby act both as the dielectric for the capacitance of the sensor and as an electric insulator between the electrodes 115, 125 and the substrate 100.

According to a possible implementation, the porous material 108 can be based on the material of the substrate 100 which is made porous. The porous material 108 can for example be porous Si when the substrate 100 is a substrate of bulk silicon.

The porous material 108 can comprise small diameter pores for example between 2 nm and 100 nm. This enables small humidity or gas quantities to be detected.

The porous material 108 can be provided with an open porosity comprised between for example 20% and 60% and preferably greater than 30%. This enables a significant developed surface to be obtained and a significant number of low humidity water molecules to be fixed.

The porous material 108 can also comprise or possibly be based on a porous dielectric material.

According to a particular application of the capacitive sensor, the latter can be integrated in a humidity detection or humidity quantity measurement device.

In this case, the porous material 108 can comprise hydrophilic sites. When humidity varies in the atmosphere surrounding the capacitance, the permittivity of the layer of porous material which adsorbs humidity is modified in proportion to the quantity of adsorbed water. This variation can be significant even with a low humidity in so far as the dielectric permittivity of water is much greater than that of the considered porous material. The dielectric permittivity c of the porous material 108 can be for example in the order of 12 when the porous material 108 is Si, whereas the dielectric permittivity ε of water is in the order of 80.

The sensor can be adapted to measurements of humidity contents from 0 to 20% RH and having a significant sensitivity for low humidity contents, for example 2 5 between 0 and 10% RH.

According to another possible particular application of the capacitive sensor, the latter can be integrated in a gas detection or gas quantity measurement device. In this case, the porous material 108 can be functionalized.

For example, to detect CO₂, the porous material is functionalized with a compound of the poly(allilamine) type having the formula: [CH₂CH(CH₂NH₂)]n).

To detect NO₂, the porous material is for example covered with ITO (Indium Tin Oxide).

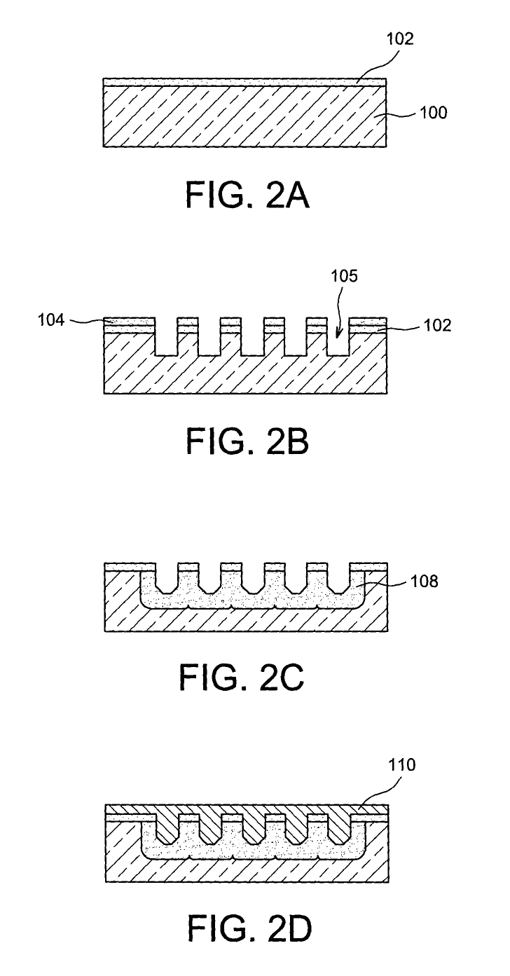

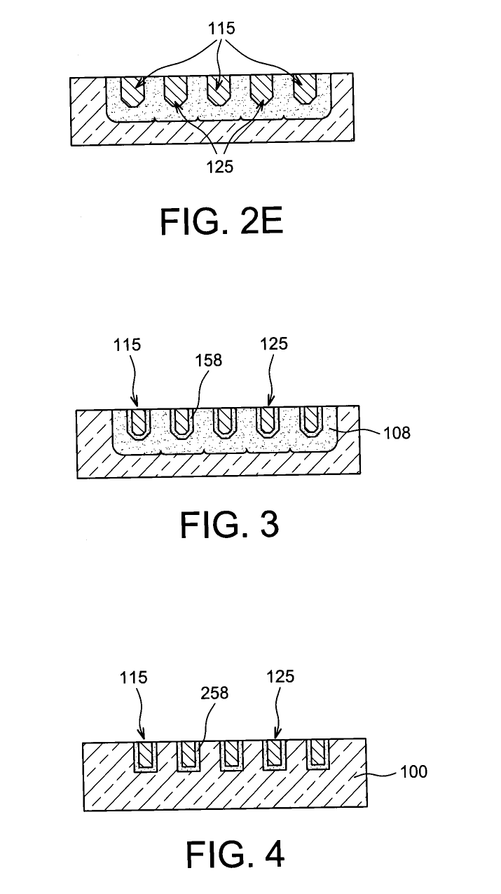

An exemplary method according to the invention for producing a capacitive sensor of the type just described, will now be given in relation to FIGS. 2A to 2E.

The starting material of this method can be a carrier or a wafer of the semi-conducting material, for example an Si substrate 100 with a thickness for example in the order of 725 μm, which can comprise a polished front face (FIG. 2A).

Then, a protective layer 102 is formed on a face of the substrate 100. This protective layer 102 is provided to protect the areas of the substrate it covers during a subsequent porosification step.

The protective layer 102 can in particular be based on a material likely to resist a chemical attack based on HF. The protective layer 102 can thus be for example based on Si₃N₄ and have a thickness for example in the order of 30 nm. The protective layer 102 can alternatively be performed by oxidizing the carrier 100, so as to form a silicon oxide TeOS layer, then by depositing a Si₃N₄ layer on the TeOS layer (FIG. 2B).

Trenches 105 are then made in the substrate 100 which go through the protective layer 102. To do this, etching the protective layer 102 through a masking 104 with openings can be made.

The openings are thus reproduced in the protective layer 102. The implemented masking 104 can for example be based on a photoresist.

Then, the substrate 100 is etched by using the protective layer 102 as a hard mask. The trenches 105 formed in the substrate 100 can have a depth for example comprised between 1 μm and 5 μm (FIG. 2B).

For some applications, the trenches can be deeper for example in the order of 20 μm.

The resin masking 104 is then removed.

Making vertical trenches can comprise one or several etching step(s) using SF₆ followed by step(s) using C₄F₈ to perform a passivation of the walls and the bottom of the trenches. After etching, a step of removing C₄F₈ from the walls and the bottom of the trenches can be implemented. This removing step can be performed for example using an O₂ plasma and an annealing under oxygen at 400° C. Then deoxidizing the surface is carried out, for example using for example 1% or 5% HF in order to remove an oxide thickness formed and likely to contain C₄F₈ residues.

After this treatment, the obtained surface of the flanks and of the bottom of the trenches is decontaminated.

One or more additional elimination then deoxidizing cycles can possibly be performed in order to obtain a total decontamination of the substrate 100 material revealed by the trenches.

Porosifying the carrier material at the walls and the bottom of the trenches 105 is then carried out. The substrate 100 material can thus be made porous in an area adjoining or bordering the trenches (FIG. 2C).

This porosification can be electrochemically performed, and more precisely by anodic dissolution in a hydrofluoric acid medium, in particular when the substrate 100 is based on Si. To do this, the substrate 100 can be submerged in a hydrofluoric acid medium having a concentration that can vary for example between 1% and 50%.

During such a method, the areas of the face of the substrate 100 revealed by the openings made in the protective layer 102 are consumed as the anodizing progresses whereas the other face of the substrate 100 acts as a contacting unit for polarizing means. The formed thickness of porous material 108 can be for example comprised between 1 μm and 3 μm.

The carrier material situated at the bottom and at the walls of the trenches is thus only made porous once the latter have been performed.

Etching in a non-porous material enables the trenches to be better defined, whereas by porosifying after the trenches are formed, pores are prevented from being contaminated with the product used for etching or deoxidizing, in particular C₄F₈ which has hydrophobic properties.

A porous material without contaminant and of a better quality is thus obtained.

Then, electrodes are formed for the sensor. To do this, depositing a conducting material 110 in the trenches 105 (FIG. 2D) is first carried out. The conducting material 110 can be a metallic material such as AlCu. Depositing can be made for example by PECVD (plasma enhanced chemical vapour deposition).

Then, to remove regions from a conducting material 110 protruding from the mouth of the trenches, planarizing or polishing can be made, for example by CMP (chemical mechanical polishing), in order to form electrodes 115, 125. The layer 102 which acted as a protective mask during porosifying can advantageously further act as a polishing barrier layer of the conducting material 102. This layer 102 can be later removed (FIG. 2E).

A treatment to make the porous material 108 hydrophilic can be performed, in particular when the sensor is intended to act as a humidity sensor. This treatment can be performed for example using H₂O₂. Treatment to make the porous material 108 hydrophilic can be performed, in particular when the sensor is intended to act as a humidity sensor.

This treatment can be performed between the porosification step and prior to the filling step of filling the trenches 105 with the conducting material 110 or well after removing the layers 110 and 102 by CMP.

According to an alternative method for producing the sensor, a step of functionalizing the porous material 108, in particular at the walls of the trenches 105 can be performed, especially when the sensor is intended to act as a gas sensor.

This functionalizing can be performed for example after the porosification step and prior to the filling step of filling the trenches 105 with the conducting material 110. For example, in order to detect CO₂, a porous material can be functionalized with a compound of the poly(allilamine) type (having the chemical formula: [CH₂CH(CH₂NH₂)]ₙ). In order to detect NO₂, the porous material is for example covered with ITO (Indium Tin Oxide).

According to an alternative embodiment of the sensor shown in FIG. 3, after porosification is carried out, the walls of the trenches can be covered with one or several layers of porous dielectric material 158, for example of the SiOCH or MSQ type.

According to a further alternative embodiment of the sensor shown in FIG. 4, after the trenches 105 are made, the porosification step can be performed in order to form the areas of porous dielectric material 258 at the walls and at the bottom of the trenches 105 and which do not contact each other.

The dielectric material 258 can be a material likely to adsorb the water molecules when the sensor is intended to detect humidity or a specific porous material dedicated to detecting particular gases such as CO, CO₂, NO₂ and CH₄.

Then, the trenches 105 are filled with a conducting material so as to form the electrodes 115 and 125. For this alternative, a porous dielectric material 258 situated around and in contact with one of the electrodes 115, 125 is arranged in order to insulate the electrodes 115 and 125 from each other and to insulate the electrodes 115, 125 from the substrate 100. In this example, the areas 258 of porous dielectric material and the electrodes coated by these areas 258 are separated from each other by regions of the substrate 100.

Such an embodiment can be provided in the cases where the porous dielectric material of the areas 258 is chemically deposited, for example by PECVD or in a case where the thickness of the porous material electrochemically formed is thin.

For this alternative, the thickness of the porous material covering the walls and the bottom of the trenches can be provided thick and preferably at least equal to 2 μm to enable a diffusion of gas or water vapour into said porous material.

An exemplary and detailed particular embodiment of a capacitive sensor will now be given.

In this example, the sensor is provided with a theoretical capacitance at 0% of relative humidity (RH) of 45 pf, and with a number of secondary conducting branches 115a, 115b, 115c, 115d, 125a, 125b, 125c, in the order of 150.

The secondary branches have a length in the order of 1000 μm, a thickness in the order of 3 μm, and are separated from each other by a distance in the order of 1.2 μm.

In this example, the porous material 108 is Si and has a thickness in the order of 3 μm, a permittivity in the order of 12, and an open porosity in the order of 35%.

The applications of a sensor according to the invention are numerous.

Among these applications, other than humidity detection in sealed components, humidity measurement in the ceramic industry for the drying control of the pieces before firing, humidity measurement in paper mills and stationary stores, humidity measurement in the food industry, in greenhouses, in the electronic industry for the control of clean rooms, in hospitals, in automobile compartments can be mentioned.

A sensor according to the invention can also be used for measuring water traces in gases produced on a large scale in an industrial site for example at extraction sites.

A sensor according to the invention can also be used within a gas controlling device for example in an industrial site where humidity is forbidden especially in methods for synthetizing pure materials such as pharmaceutical or for example in sites for manufacturing polymers.

A sensor according to the invention can also be used for detecting leaks in encapsulated components in the microelectronic industry and microsystems of the accelerometer, gyrometer or pressure sensors type which are protected by a casing.

1-7. (canceled)

8. A method for producing a capacitive sensor, comprising:
forming trenches in a carrier based at least on one given material by etching the at least one given material;
making the given material porous at walls and bottom of the trenches;
filling the trenches using a conducting material.

9. The method according to claim 8, wherein the trenches are made through a protective masking, the method further comprising, after the filling the trenches, removal by planarization of areas of the conducting material protruding from a mouth of the trenches.

10. The method according to claim 8, further comprising a treatment to make the given porous material hydrophilic.

11. The method according to claim 8, further comprising functionalizing the porous material.

12. The method according to claim 8, wherein the carrier is a silicon-base substrate.

13. The method according to claim 8, further comprising, after the making the given material porous, and prior to the filling the trenches: depositing a dielectric material in the trenches.

14. The method according to claim 8, wherein the forming the trenches comprises alternating etching phases with SF₆ and passivation phases using C₄F₈ followed by one or plural treatment using O₂ plasma.
